(19) United States
(12) Patent Application Publication
(10) Pub. No.: US 2013/0025730 A1
(43) Pub. Date: Jan. 31, 2013

(54) DOMESTIC SERVICE PIPE SYSTEM AND USE THEREOF

(71) Applicants: Bernd Röder, Erlangen (DE); Thomas Lanzl, Marktredwitz (DE); Frank Pohlmann, Rehau (DE)

(72) Inventors: Bernd Röder, Erlangen (DE); Thomas Lanzl, Marktredwitz (DE); Frank Pohlmann, Rehau (DE)

(21) Appl. No.: 13/640,486

(22) PCT Filed: Apr. 11, 2011
(86) PCT No.: PCT/EP11/01784

§ 371 Date: Oct. 11, 2012

(30) Foreign Application Priority Data
Apr. 14, 2010 (DE) 10 2010 015 022.3

(51) Int. Cl. F16L 47/16

(52) U.S. Cl. 138/109

(57) ABSTRACT

The present invention relates to a domestic service pipe system which comprises the following components: solid plastic pipes, composite plastic pipes and/or composite metal/plastic pipes as line pipes (3, 3′, 3″); threadless shaped parts of temperature-resistant plastic and/or stainless steel; and threaded shaped parts (1, 1′) of stainless steel. Moreover, the present invention relates to the use of such a domestic service pipe system as a line and connection system in a drinking water installation, in a sprinkler system, in radiator connections, in a concrete core temperature control system and in a panel heating and/or panel cooling system.

The present invention relates to a domestic service pipe system and use thereof.

Such domestic service pipe systems are known in the prior art. Numerous service pipe systems having different varieties of materials used in the components comprising the system are distributed on the market, with various joining techniques being used for the different installation systems. Thus, entirely metal systems with pipes and molded parts made of metal materials such as stainless steel and brass as well as plastic pipe systems and composite pipe systems have become established on the market. Systems made entirely of metal have a greater mechanical load capacity but are very rigid and therefore they are difficult to assemble. Plastic pipe systems and composite pipe systems in particular are characterized by a high flexibility of the pipe system and by a sturdy joining technique, which makes them quick to install, so that in particular radial pressing, sliding, screwing and plug connections in some cases have become popular as joining techniques. Therefore installation pipe systems having plastic pipes or composite pipes are said to be extremely easy to assemble, in particular in floor heating systems.

In the field of plastic and composite pipe systems, copper alloys such as brass and red bronze as well as temperature-resistant plastics such as polyphenylsulfone (PPSU) and polyvinylidene fluoride (PVDF) have so far been used as the materials for molded parts. Based on the high mechanical loads, threaded molded parts made primarily of copper materials have so far been used predominantly. In addition, parts made of plastic materials have also come on the market for threaded molded parts and threadless molded parts, such as fittings, but they have not yet been widely successful. In addition, threaded molded parts made of plastic materials have not yet offered adequate mechanical stability, whereas the requirements of the migration properties of copper alloys with regard to releasing metal ions such a lead ions, iron ions and copper ions have been increasing. In addition, such copper alloys have a tendency to corrode.

Thus the object of the present invention is to make available a domestic service pipe system which overcomes the disadvantages of the prior art. In particular the domestic service pipe system according to the invention should have a high flexibility with a robust joining technology that is quick to install and very easy to assemble.

Furthermore, the domestic service pipe system according to the invention should have good corrosion resistance and should only release very small quantities of metal ions under critical water conditions in particular (i.e., soft groundwater, softened water, low pH levels and high alkali metal salt levels, in particular chlorides, sulfates and nitrates).

These and other objects are achieved by a domestic service pipe system having the features of claim 1 and/or through the use of a domestic service pipe system according to the invention, as disclosed in claim 6. Preferred embodiments of the domestic service pipe system according to the invention are described in the dependent claims.

It has been recognized according to the present invention that the advantageous migration behavior of plastic materials and stainless steel can be utilized for such a domestic service pipe system when threadless molded parts and threaded molded parts are manufactured from temperature-resistant plastic and/or stainless steel. In addition, it has been recognized according to the present invention that threaded molded parts made of stainless steel can withstand the high mechanical loads occurring with such threaded molded parts. In addition, threadless molded parts and threaded molded parts made of the aforementioned materials have a high flexibility when installing a solid plastic pipe system, a composite plastic pipe system and/or a composite metal-plastic pipe system or combinations of the aforementioned pipe systems as pipelines, wherein the components used for the line pipes naturally exhibit good migration and corrosion properties.

Accordingly, the present invention consists of providing a domestic service pipe system, which includes solid plastic pipes, composite plastic pipes and/or composite metal plastic pipes as line pipes; threadless molded parts made of temperature-resistant plastic and/or stainless steel and threaded molded parts made of stainless steel.

In addition, the present invention consists of using such a domestic service pipe system as a line and connection system in a drinking water installation system, in a sprinkler system, in heater connections, in a concrete core temperature control system and in a panel heating and/or panel cooling system.

The term “temperature-resistant plastics” as used here relates to the dimensional stability in heat and the thermal stability of this group of materials and characterizes polymer materials, in particular thermoplastic polymer materials with a dimensional stability in the heat at temperatures of at least 150° C. The upper temperature limit at which such a temperature-resistant plastic can be used depends on the material used, and the usable temperature range of such polymer materials ends at max. 260° C.

In the present patent application, the term “stainless steel” describes steels according to DIN EN 10027. The preferred steels are V2A and V4A steels, in particular those with the material numbers 1.4301 (X5CrNi18-10), 1.4401 (X5CrNiMo17-12-2), 1.4404 (X2C4NiMo17-12-2) and 1.4571 (X6CrNiMoTi17-12-2) according to DIN EN 10027-2 are preferred, but the stainless steel with the number 1.4401 (X5CrNiMo17-12-2) is especially preferred.

The term “threadless molded parts” as used here refers to fittings that do not have a thread in a domestic service pipe system. This includes in particular connection pieces, connection brackets, multiple distributors, T pieces, wall T pieces, wall brackets, system transitions, transition pieces, angled transition pieces, each of which does not have a thread. Similarly, the term “threaded molded parts” refers to fittings within a domestic service pipe system which have a thread. This includes in particular connection pieces, connection brackets, multiple distributors, T pieces, wall T pieces, wall brackets, system transitions, transition pieces, angled transition pieces, each of which has at least one inside thread and/or outside thread.

According to the present invention, solid plastic pipes used as line pipes are preferably made of polyethylene (PE, in particular PE 100 and PE-RT), crosslinked polyethylene (PE-X, in particular PE Xa and PE Xb), polypropylene (random polypropylene PP-R) and polybutylene (PB); composite plastic pipes, preferably with layers of polyethylene (PE, in particular PE 100 and PE-RT), crosslinked polyethylene (PE-X, in particular PE Xa and PE Xb), polypropylene (random polypropylene PP-R) and/or polybutylene (PB); and composite metal-plastic pipes (CMP pipes), preferably with layers of polyethylene (PE, in particular PE 100 and PE-RT), crosslinked polyethylene (PE-X, in particular PE Xa and PE Xb), polypropylene (random polypropylene PP-R) and/or polybutylene (PB); and at least one layer of metals, preferably aluminum. Adhesion promoter layers may be provided between individual layers in the case of composite plastic pipes and composite metal-plastic (CMP) pipes. According to the present invention, all line pipes may have an identical structure or one or more of the line pipes may have a different structure. In addition, the line pipes according to the present invention may also be fiber-reinforced. The fiber reinforcement of the line pipes may be present in some or all line pipes, over the entire pipe length or only in sections.

In preferred embodiments of the present invention, threaded molded parts made of stainless steel and threadless molded parts made only of temperature-resistant plastic are used as the molded parts. The cost of materials for the domestic service pipe system according to the invention is therefore reduced.

In other preferred embodiments of the present invention, threaded molded parts may be made of temperature-resistant plastic, such that these threaded molded parts made of temperature-resistant plastics may have at least one threaded insert made of stainless steel in the thread area in the case of an inside thread and/or at least one thread cap made of stainless steel in the case of an outside thread.

With respect to the domestic service pipe system according to the invention, it may be advantageous if the connection of the line pipes to both threadless molded parts and threaded molded parts is designed as a press-fit connection with a sliding sleeve. This type of connection technique has proven to be especially suitable in practice for solid plastic pipes, composite plastic pipes and/or composite metal-plastic pipes.

It may prove to be particularly advantageous if the sliding sleeves are made of temperature-resistant plastic. Sliding sleeves of temperature-resistant plastic can be used with a lower pressing force in press-fit connections with a sliding sleeve in comparison with those made of metallic materials, and this facilitates assembly of a domestic service pipe system. In addition, such a sliding sleeve made of a temperature-resistant plastic causes less deformation in the collar of the respective fitting in pressing, which increases the reliability of the joining technique. In particular polyphenylsulfone (PPSU), polyvinylidene fluoride (PVDF), polyether sulfone (PES), polyphenylene sulfide (PPS) and polyester carbonate (PESC) as well as copolymers and blends of these copolymers have proven to be suitable plastic materials for use as the temperature-resistant plastic according to the present invention. PVDF is preferred as the plastic material for the sliding sleeves and PPSU is preferred for the threadless molded parts.

The present invention is explained in greater detail below with reference to the embodiment illustrated in the figures.

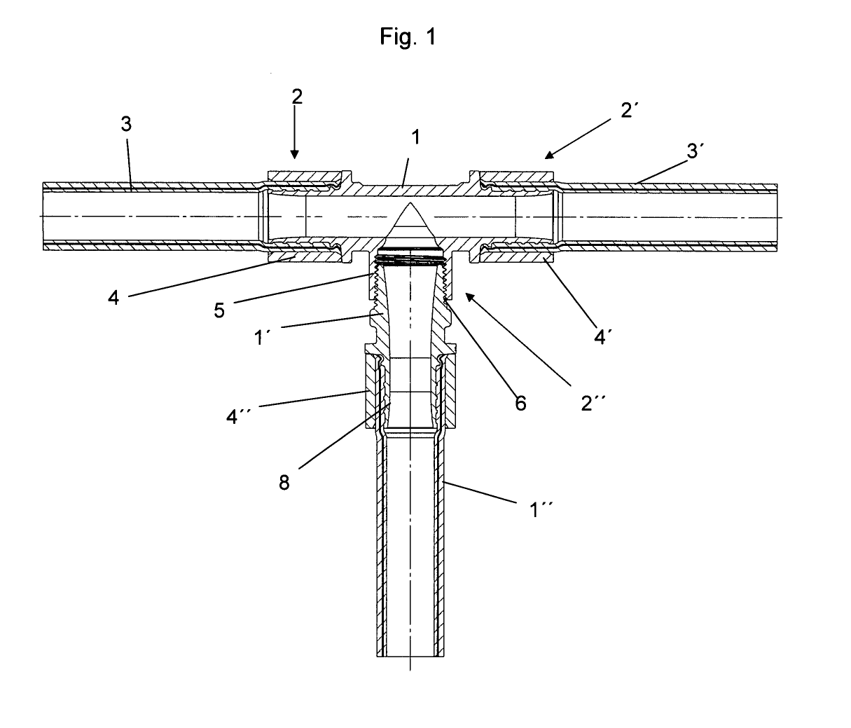

FIG. 1 shows a cross-sectional diagram of a T piece having a threaded connection, which may be used in an embodiment of the domestic service pipe system according to the invention.

FIG. 1 shows a cross section of a joining area in an domestic service pipe system according to the invention. The threaded molded part 1 shown there is designed in a T shape having three connection areas 2, 2′ and 2″, such that line pipes 3, 3′ are secured on the threaded molded part 1 with the help of press-fit connections using sliding sleeves 4, 4′ in the connection areas 2 and 2′. In the third connection area 2″, the threaded molded part 1 has an inside thread 5 into which an outside thread 6 of another threaded molded part 1″ is screwed. A Teflon strip 7 or alternatively a thread sealing tape is introduced into the threaded connection for sealing purposes.

On the side facing away from the outside thread 6, the thread of molded part 1′ has a connection 8 which is attached to the line pipe 3″ by a press-fit connection with a sliding sleeve 4″.

Threaded molded parts 1, 1′ as well as additional threaded molded parts of the domestic service pipe system according to the invention are preferably made of stainless steel, especially V2A and V4A steels, but the stainless steels with material numbers 1.4301, 1.4401, 1.4404 and 1.4571 according to DIN EN 10027-2 are especially preferred. Threadless molded parts which are used in the domestic service pipe system according to the invention are made of temperature-resistant plastic and/or stainless steel. According to the invention, the preferred temperature-resistant plastics used here include polyphenylsulfone, polyvinylidene fluoride, polyether sulfone, polyphenylene sulfide and polyester carbonate as well as copolymers and blends of these polymers. The preferred stainless steel for the threadless molded parts is preferably also that used for the threaded molded parts. The sliding sleeves are also made of temperature-resistant plastic but preferably the materials described with respect to the threadless molded parts are used. PVDF is the preferred temperature-resistant plastic materials for the sliding sleeves and PPSU is preferred for the threadless molded parts.

The line pipes 3, 3′, 3″ in the embodiment of the domestic service pipe system according to the invention shown in a detail in FIG. 1 are composite metal-plastic pipes (CMP pipes), where the layer facing the lumen of the types 3, 3′, 3″ is a layer of crosslinked polyethylene (PE-X, in particular PE Xa or PE Xb) bonded to an aluminum layer and also a layer of crosslinked polyethylene. To improve the adhesion of the PE-X to the aluminum layer, an adhesion promoter layer may be applied in at least some sections to the side of the aluminum layer facing the lumen and/or to the side facing away from the lumen. Likewise at least one of the PE-X layers may be replaced by a layer of another polymer material such as polyethylene (PE, in particular PE 100 and PE-RT), polypropylene (in particular random polypropylene PP-R) and/or polybutylene (PB) and/or the CMP pipe may include additional layers of these polymer materials.

In other embodiments of the present invention, the pipes 3, 3′, 3″ are solid plastic pipes, preferably made of polyethylene (PE, in particular PE 100 and PE-RT), crosslinked polyethylene (PE-X, in particular PE-Xa and PE-Xb), polypropylene (in particular, random polypropylene PP-R) and polybutylene (PB).

As an alternative to this composite plastic pipes, preferably with layers of polyethylene (PE, in particular PE 100 and PERT), crosslinked polyethylene (PE-X, in particular PE-Xa and PE-Xb), polypropylene (random polypropylene PP-R) and/or polybutylene (PB) may be used as line pipes 3, 3′, 3″ in the domestic service pipe system according to the invention. According to the present invention, all line pipes 3, 3′, 3″ may have an identical structure or the line pipes 3, 3′, 3″ may have different structures.

The domestic service pipe system according to the invention offers advantageous migration and corrosion behavior with simple and flexible assembly and may be used in particular as a line and connection system in a drinking water installation system, in a sprinkler system, in a heater connection, in a concrete core temperature control system and in a panel heating and/or panel cooling system.

1. A domestic service pipe system, comprising the following components:
line pipes (3, 3′, 3″) made of a material selected from a group of materials consisting of solid plastic, composite plastic and composite metal-plastic;
threadless molded parts made of temperature-resistant, stain resistant material; and
threaded molded parts (1, 1′) made of stainless steel.

2. The domestic service pipe system according to claim 1, wherein it comprises threadless molded parts made only of temperature-resistant plastic.

3. The domestic service pipe system according to claim 1, wherein the connection of the line pipes (3, 3′, 3″) to the threadless molded parts and the threaded molded parts (1, 1′) is embodied as a press-fit connection with a sliding sleeve (4, 4′, 4″).

4. The domestic service pipe system according to claim 3, wherein the sliding sleeves (4, 4′, 4″) are made of a temperature-resistant plastic.

5. The domestic service pipe system according to claim 1 wherein a temperature-resistant plastic is selected from the group consisting of polyphenylsulfone, polyvinylidene fluoride, polyether sulfone, polyphenylene sulfide and polyester carbonate as well as copolymers and blends of these polymers.

6. A use of a domestic service pipe system according to claim 1 as a line and connection system in a drinking water installation, in a sprinkler system, in heater connections, in a concrete core temperature control system and in a panel heating and/or panel cooling system.

7. The domestic service pipe system according to claim 1, wherein it comprises threadless molded parts made only of stainless steel.

8. The domestic service pipe system according to claim 2, wherin the connection of the line pipes (3,3′,3″) to the threadless molded parts and the threaded molded parts (1,1′) is embodied as a press-fit connection with a sliding sleeve (4,4′4″).

9. The domestic service pipe system according to claim 2 wherein a temperature-resistant plastic is selected from the group consisting of polyphenylsulfone, polyvinylidene fluoride, polyether sulfone, polyphenylene sulfide and polyester carbonate as well as copolymers and blends of these polymers.

10. The domestic service pipe system according to claim 3 wherein a temperature-resistant plastic is selected from the group consisting of polyphenylsulfone, polyvinylidene fluoride, polyether sulfone, polyphenylene sulfide and polyester carbonate as well as copolymers and blends of these polymers.

11. The domestic service pipe system according to claim 4 wherein a temperature-resistant plastic is selected from the group consisting of polyphenylsulfone, polyvinylidene fluoride, polyether sulfone, polyphenylene sulfide and polyester carbonate as well as copolymers and blends of these polymers.

12. A use of a domestic service pipe system according to claim 2 as a line and connection system in a drinking water installation, in a sprinkler system, in heater connections, in a concrete core temperature control system and in a panel heating and/or panel cooling system.

13. A use of a domestic service pipe system according to claim 3 as a line and connection system in a drinking water installation, in a sprinkler system, in heater connections, in a concrete core temperature control system and in a panel heating and/or panel cooling system.

14. A use of a domestic service pipe system according to claim 4 as a line and connection system in a drinking water installation, in a sprinkler system, in heater connections, in a concrete core temperature control system and in a panel heating and/or panel cooling system.

15. A use of a domestic service pipe system according to claim 5 as a line and connection system in a drinking water installation, in a sprinkler system, in heater connections, in a concrete core temperature control system and in a panel heating and/or panel cooling system.
